(19) United States
(12) Patent Application Publication
(10) Pub. No.: US 2017/0036106 A1
(43) Pub. Date: Feb. 9, 2017

(54) Method and System for Portraying a Portal with User-Selectable Icons on a Large Format Display System

(71) Applicants: I/P SOLUTIONS, INC., PERRYSBURG, OH (US); ABOUTGOLF, LIMITED, MAUMEE, OH (US)

(72) Inventors: THEODORE J. STECHSCHULTE, MAUMEE, OH (US); WALLACE MAASS, PERRYSBURG, OH (US)

(73) Assignees: I/P SOLUTION, INC., PERRYSBURG, OH (US); ABOUTGOLF, LIMITED, MAUMEE, OH (US)

(21) Appl. No.: 14/999,885

(22) PCT Filed: Jan. 21, 2015
(86) PCT No.: PCT/US2015/012262

§ 371 Date: Jul. 14, 2016

Related U.S. Application Data
(60) Provisional application No. 61/929,772, filed on Jan. 21, 2014.

(51) Int. Cl. A63F 13/25; A63F 13/822; A63F 13/335; A63F 13/812

(52) U.S. Cl. CPC A63F 13/25; A63F 13/812; A63F 13/822; A63F 13/335

(57) ABSTRACT

A display system for providing user interactive, immersive activity is disclosed. The system includes a simulation controller and a video display system having an actively viewable height of at least six feet or more, the video display system having one or more actively viewable surfaces. One or more input devices are configured to receive inputs from a user. The simulation controller is configured to cause to be displayed display on the one or more actively viewable surfaces a user interactive, immersive activity in a first mode. The simulation controller is responsive to receiving a first input from the one or more input devices to activate a second mode in which content unrelated to the user interactive, immersive activity is caused to be displayed on the one or more actively viewable surfaces.

### PRIORITY CLAIM

This application claims priority from U.S. Provisional Application No. 61/929,772 filed on Jan. 21, 2014. The entirety of that application is hereby incorporated by reference.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD

The present invention relates generally to simulator systems, and, more particularly, to a system that allows a user to participate in an interactive activity in a first mode and use the system for a second unrelated mode.

### BACKGROUND

Traditionally, athletes have had to find actual physical locations such as an athletic facility or a driving range. The availability of such facilities was limited and often required an athlete to travel some distance. Crude simulators have always been used in different activities such as sports or in order to improve player skills without having to travel to an actual facility. Such equipment could be used to train an athlete in physical skills or tactical skills in a sport. For example, a simulation in the form of a game could be valuable in training an athlete in tactics or plays in a sport. While initially designed to assist a player in improving their skills, simulated games based on sports have spawned their own subgenre, where the game itself replaces the actual sport for a player. From its inception, the video game industry has based games on sports themes. Such games have evolved as the games have become more complex and factors such as object movement, strategy and tactics, environmental factors, graphics, etc., have become more realistic. However, video games attempting to place a player in an immersive environment such as playing a sport to experience an actual player are limited by their hardware. For example, current video games are designed either for conventional televisions or computer screens. Although graphic quality may be high, a user is not entirely immersed in the environment because it is clear that the game is occurring on a relatively finite sized display screen.

As game technology has involved, the desire for more realistic physical simulation in an as close to reality environment has increased. For example, players may wish to coordinate their physical movements in a sport with a simulated immersive environment and thereby experience both the physical and mental aspects of a sport. For convenience, users may access a video game simulation of the game, but such a game, as explained above, does not offer an actual environment similar to a real sports experience.

Thus, there is a need for a system that provides an immersive experience for a user using a large scale display. There is a need for an immersive system that allows individuals wishing to increase their proficiency in a given skill in an activity could take advantage of both the instruction as well as the direct comparison in performance with experts such as professional players. There is a need for system that may use large screens for the immersive environment for other media. There is a need for system that generates an instructional avatar to assist a user in practicing in the immersive environment.

### SUMMARY

According to one example, a display system including a simulation controller and a video display system having an actively viewable height of at least six feet or more is disclosed. The video display system has one or more actively viewable surfaces. One or more input devices are coupled to the simulation controller and configured to receive inputs from the human user or another user. The simulation controller displays on the one or more actively viewable surfaces a user interactive, immersive activity in a first mode. The simulation controller is configured to, responsive to receiving a first input from the one or more input devices, activate a second mode in which content unrelated to the user interactive, immersive activity is displayed on the one or more actively viewable surfaces.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a block diagram of an example system for operating an immersive, interactive activity;

FIG. 2 is a perspective view of an example sports based simulator system using the example system of FIG. 1;

FIG. 3 is a perspective view of the example sports based simulator system in FIG. 2 showing a human user;

FIG. 4 is a screen image of a selection menu for the example simulator system that allows the use of a display for a second mode other than the sports based simulator; and

FIGS. 5A-5E are screen images of selections from the selection menu in FIG. 4 that enable control of features for the second mode of the example simulator system.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

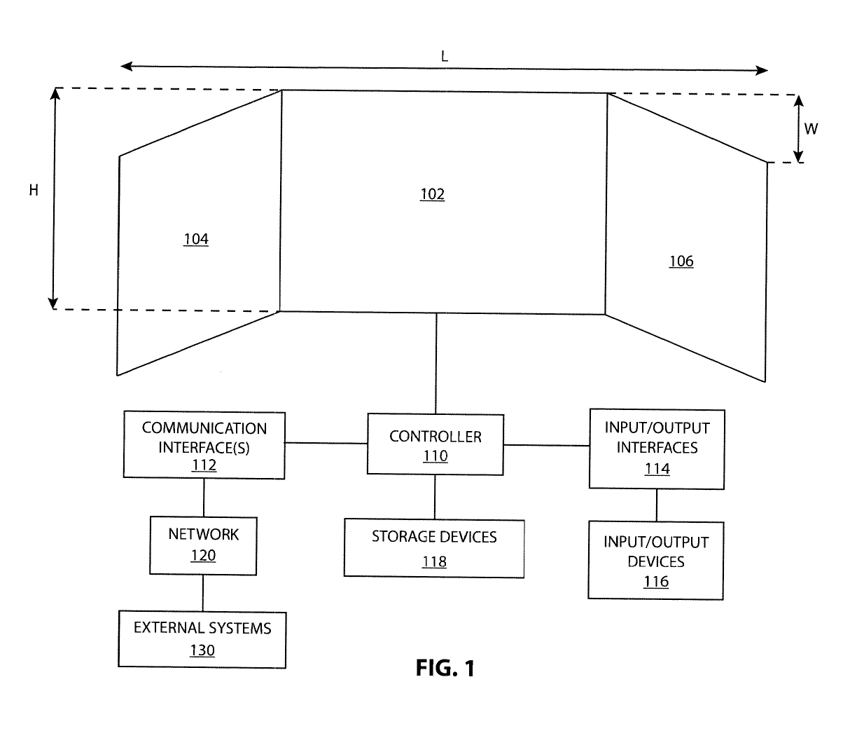

A display system 100 is shown in FIG. 1 according to aspects of the present disclosure. The display system 100 includes a simulation controller 110, a video display system including screens 102, 104, 106, one or more communication wired or wireless interfaces 112, one or more input and/or output interfaces 114 and one or more corresponding input and/or output devices 116, and one or more storage devices 118. The simulation controller 110 is a specialized computational device for performing simulations and integrating multi-media content. The simulation controller 110 may include one or more controllers or processors as those terms are understood by those skilled in the art of computer technology. The simulation controller 110 may also include one or more general purpose computer systems, microprocessors, digital signal processors, micro-controllers, application specific integrated circuits (ASIC), programmable logic devices (PLD), field programmable logic devices (FPLD), field programmable gate arrays (FPGA) and the like.

The communication interface(s) 112 can be coupled to a television or video streaming source such as a satellite media system or a network 120, such as to the Internet or a private network, which in turn is coupled to one or more external systems 130. The external systems 130 are external to and remote from the display system 100.

The video display system screens or surfaces 102, 104, 106 each have an actively viewable height (H) of at least six feet or more and preferably about ten feet in this example. The “actively viewable” portion(s) of the display system 100 refer to those areas on which a projected or emitted image appears and is visible to a human user positioned in front of the display system. For example, any bezel or frame is excluded from the actively viewable portion of the display system 100. In the illustrated example, there are three distinct actively viewable screens or surfaces 102, 104, 106, though the present disclosure is not limited to three. For example, the entire viewable surface corresponding to the display system 100 may be continuously curved, or there may be one, two, or more than three actively viewable surfaces. Of course, there can be fewer than three displays as well. In this example, a video projector or plurality of synchronized video projectors, which may be one of the output interfaces 114, projects images onto the one or more viewable surfaces 102, 104, and 106. The actively viewable surfaces may partially surround the human user(s) as much as or more than 120 degrees. In order to immerse the user, the overall width of the viewable surfaces 102, 104 and 106 may be twenty feet in this example, but larger or smaller overall viewable surfaces may be used. Instead of using video projection, the video display system can include one or more displays such as one or more liquid crystal displays (LCD), plasma displays, light emitting diode displays (LEDs), quantum dot displays, or organic light emitting device (OLED) displays. The example video display system may allow 3-D projection of images to the user. Additional output devices 116 may include surround sound speakers or lighting controls to enhance the immersive experience for the user.

Example input interfaces of the input/output interfaces 114 may include any one or more of a mouse, a keyboard, a touchscreen, a joystick, a motion sensor, an accelerometer, one or more digital cameras, a digital sensing system, an infrared motion tracking system, a voice recognition system, and the like. For example, the human user can move hands, arms, or fingers to make inputs to the simulation controller 110, and these movements or gestures can be detected by a motion sensor, a digital camera, or other digital sensing system, and differentiated by the same to correspond to different inputs. The user may also make voice commands to make inputs to the simulation controller 110. If the input interfaces include a touchscreen, the touchscreen can coincide with a portion or all of the actively viewable surfaces 102, 104, 106 of the video display system. As will be explained below, user inputs may be simplified for a single click solution on a touch screen interface or a single voice/motion command in order to operate different functions enabled by the simulation controller 110.

The simulation controller 110 is configured to cause to be displayed on one, any, some, or all of the actively viewable surfaces 102, 104, 106 the graphics of a user interactive, immersive activity. The user interactive, immersive activity allows a user to physically interact in the activity. One example of a user interactive, immersive activity is a sports simulation where the user physically simulates being a player in a sport. In such a sports simulation, the simulation controller 110 causes the video display system to display the sporting venue and the user is immersed in the sporting venue. Examples of an interactive, immersive sporting simulation may include golf, baseball, basketball, football, target shooting and archery among others. Another example of a user interactive, immersive activity may be a first person role-playing game in an interactive and immersive game environment such as a first person shooter game, a ground combat simulator game, an adventure game, etc.

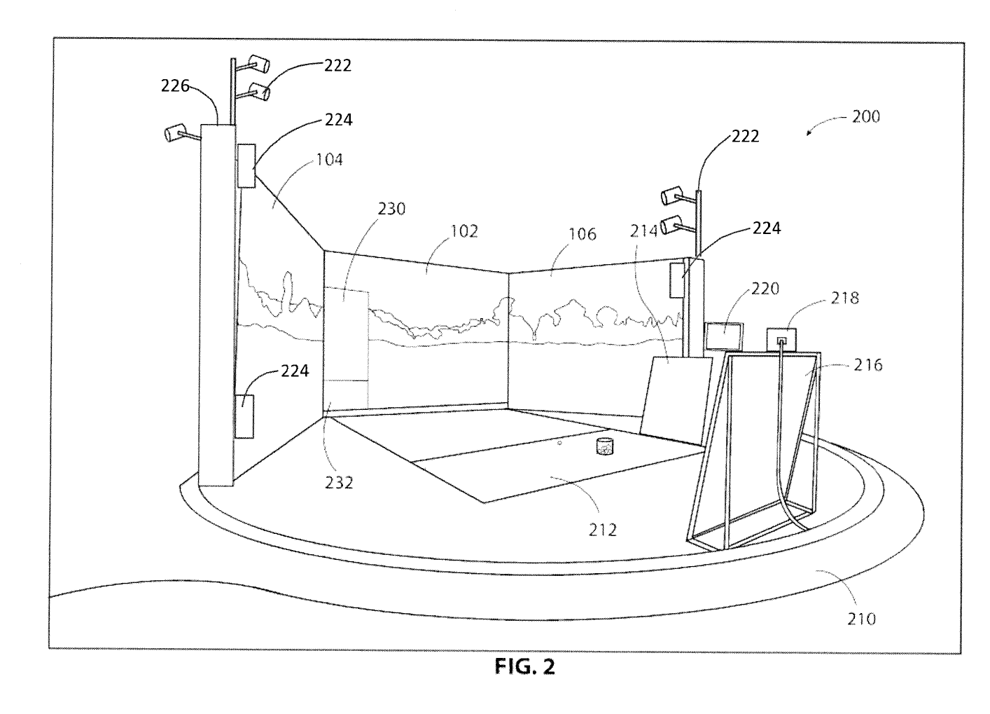

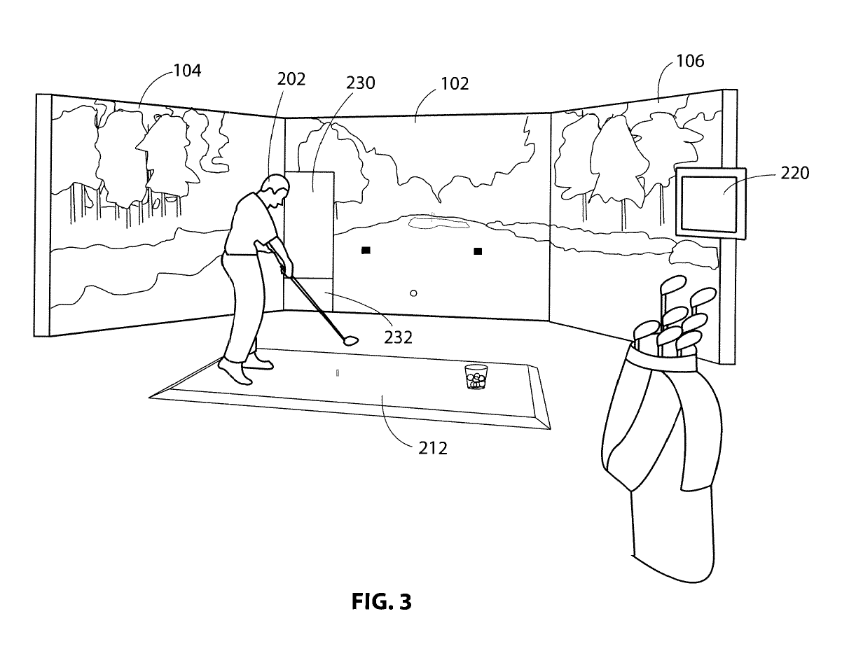

One example of a simulator system 200 that may use the display system 100 for operating a user interactive, immersive activity such as a sports simulation game is shown in FIGS. 2 and 3. Thus, the first mode of the display system 100 is to operate a user interactive, immersive activity. In this example, the display system 100 operates a golf simulator game in the first mode on the simulator system 200 as shown in FIG. 3. A user 202 thus may run simulated golf game operated by the system 100 to practice skills relating to golf or actually play a golf game in the simulator system 200. Examples of a suitable simulated golf game are available from the assignee of the present disclosure under the trade names aboutGolf® simulators, among others. Using the one or more input devices, the user 202 or another user may change between the first user interactive, immersive activity mode and a second mode in which content unrelated to the simulated sports activity or game is caused to be displayed on one, any, some, or all of the actively viewable surfaces 102, 104, 106. As will be explained below, another mode may be accessed to display media content on the display system related to the user interactive, immersive activity such as a sports simulation game.

The simulator system 200 includes a base 210 that mounts the actively viewable surfaces 102, 104 and 106 that are arranged in a semi-circular fashion around the user 202 in a manner that provides the immersive environment. As will be explained below, the user 202 may use the actively viewable surfaces 102, 104 and 106 to simulate a sport venue or environment such as a golf course in the first mode of this example as shown in FIG. 3. Of course, depending on the activity, the actively viewable surfaces 102, 104 and 106 may display other types of sports related games or simulations or other immersive, interactive activities in the first mode.

The simulator system 200 includes a platform 212 mounted on the base 210 that allows the user 202 to stand and view the displays 102, 104 and 106. In this example, other components may assist a user in the first game mode. For example, a mirror 214 may be set up to allow a user to observe their movements during playing the game. A back screen 216 may be used to mount a sensing device 218 such as a camera to record the user 202. The effect is immersive play experience and includes tracking and graphics technology based on data from sensors such as the sensing device 218. A control screen 220 may include visual or touch controls for the user to control the functions of the game mode. The control screen 220 may also allow a user to display other media content in the second mode or other modes.

The simulator system 200 creates a simulated environment for the user. Additional features may enhance the immersive environment such as output sound and lighting devices 116 in FIG. 1. An example may include lights 222 and speakers 224 mounted on a support 226. As explained above, the lights 222 and speakers 224 are controlled by the simulation controller 110 to create lighting effects and sound effects such as surround sound. These components, when combined with live data related to the sports venue allow the simulator system 200 to place a user into a separate simulated environment. Smart building systems could be coupled with the system 100 in such a manner as to effect the ambient temperature of the simulator or activate fans built in to the surroundings to simulate the wind at the sports venue or course location.

As explained above, any of the areas on the viewing surfaces 102, 104 and 106 may be allocated for a second mode or additional modes that allow a user to view other media when operating the first game mode. One example may be a screen area 230 that has been designated for media content display in the second mode. An alternative menu screen area 232 may be displayed to allow the user 202 to select other modes via an input device such as a remote control or mouse held by the user 202 rather than using the control screen 220. It is to be understood that the screen areas 230 and 232 may be displayed at any size and any location on any of the viewing surfaces 102, 104 and 106.

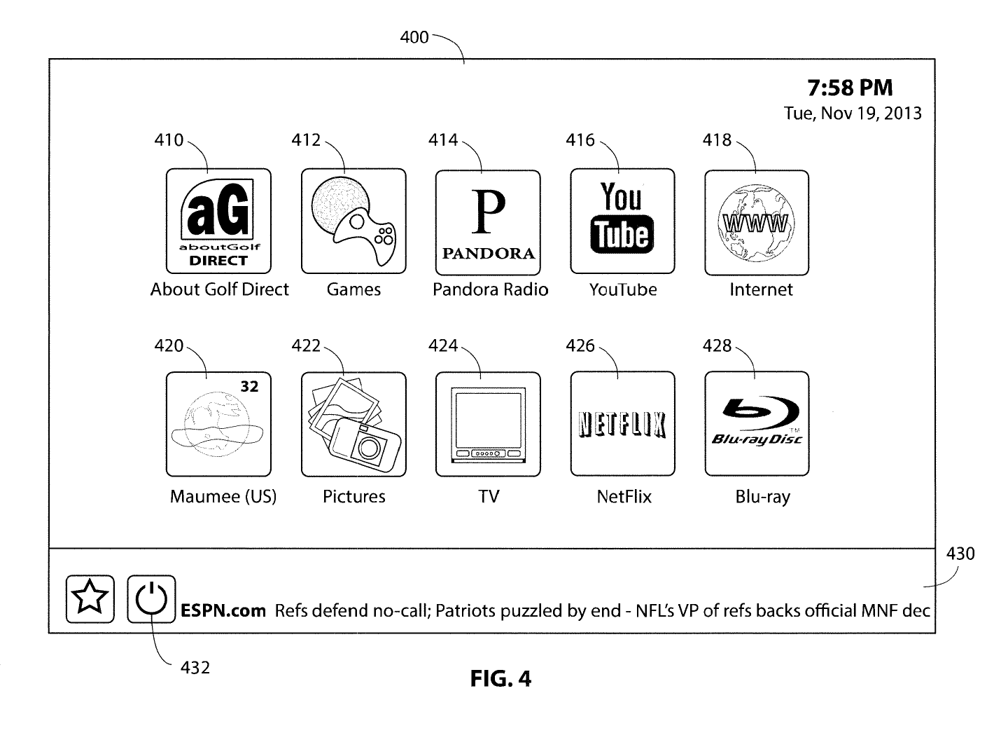

The accessible content of the second mode may be accessed in the form of a portal or dashboard and includes a menu of user selectable icons, such as those shown on an image 400 in FIG. 4, and displayed on the surface 102, or the surface 104, or the surface 106, or any combination of the surfaces 102, 104, 106. An example menu may be displayed to allow a user to select other applications to be displayed on any or all of the surfaces 102, 104 and 106 using the system 100 in FIG. 1. For example, in FIG. 2, the menu screen area 232 may display a menu image 400 shown in FIG. 4.

Ten icons are labeled 410, 412, 414, 416, 418, 420, 422, 424, 426 and 428, respectively, and are associated with respective computer-executable functions. In this example, the functions may include operating a sports game such as the golf simulator game activated by the icon 410, one or more interactive or immersive games including an online game playable via the Internet activated by the icon 412, an online streaming music service, such as PANDORA® activated by the icon 414, an online video streaming service, such as YOUTUBE® activated by the icon 416, an Internet browser activated by the icon 418, an online weather forecast service activated by the icon 420, a digital picture viewer/player activated by the icon 422, a television viewer activated by the icon 424, a second online video streaming service or player, such as NETFLIX® activated by the icon 426, and a digital disc player activated by the icon 428. The games icon 412 is this example accesses a Steam games client allowing the purchasing and playing of numerous games. Selecting an icon 410, 412, 414, 416, 418, 420, 422, 424, 426 and 428 may cause additional control menus to be displayed for additional features related to the selected function. The weather icon 420 will display current temperature, a sky condition graphic and alternatively other conditions on the icon itself

The simulation controller 110 may use media center software such as for HTPC (home theater personal computer) to portray on the video display system 100 at least some of the functions associated with the icons 410, 412, 414, 416, 418, 420, 422, 424, 426 and 428. These may be licensed or an open source media players, media center software, or other protocols such as that made available from the XBMC Foundation, among others. An informational bar 430 is located at the bottom of the screen 400 and displays sports news in this example, although other streaming information feeds may be displayed. A shut down button 432 allows a user to exit the menu 400.

Although ten user-selectable icons 410, 412, 414, 416, 418, 420, 422, 424, 426 and 428 are shown in the illustrated example of FIG. 4 along with their exemplary associated functions when selected, the present disclosure can include fewer or more than ten user-selectable icons. In this example, the applications represented by the user-selectable icons 410, 412, 414, 416, 418, 420, 422, 424, 426 and 428 are enabled by a single-click on a touch screen control such as the touch screen 220 in FIG. 2 or a single motion or voice command for maximum convenience to the user.

The user-selectable icons 410, 412, 414, 416, 418, 420, 422, 424, 426 and 428 are selectable via the one or more input devices 116 by the human user or another user. For example, while the human user (“player”) is playing the simulated sports game, another user (“bystander”) may call up the menu 400 to make selections while the original user is playing the simulated sports game.

The menu 400 may occupy the entire viewable surface of the video display system 100 and replace the simulated sports game in the first mode, which may be suspended, the menu may occupy the background in a deemphasized manner such as semi-transparently, the menu may occupy a small part of any one screen, or a combination of these. When one of the icons 410, 412, 414, 416, 418, 420, 422, 424, 426 and 428 is selected, the simulation controller 110 causes the function associated with the selected icon to be executed. The function can be executed by the simulation controller 110, by one of the external systems 130, or a combination of both. For example, selecting the online streaming music service icon 414 executes a function that causes content to be streamed from an Internet radio or music streaming service (an external system 130) via the network 120, for output by one or more receivers or speakers that may be included in the input/output devices 116. By way of another example, selecting the television viewer icon 424 executes a function that causes live or pre-recorded or time-shifted television content to be streamed from a broadcast telecast source, a cable television provider, a network media storage device, a direct-broadcast satellite source, or a webcast source.

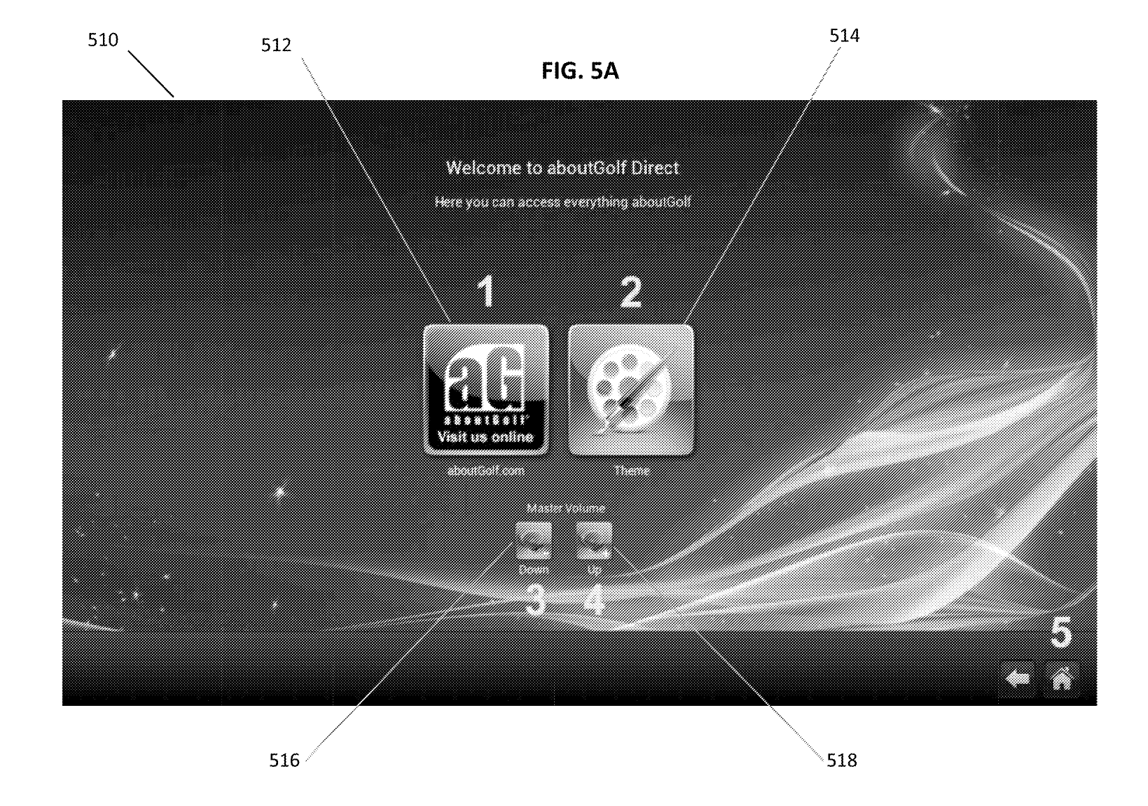

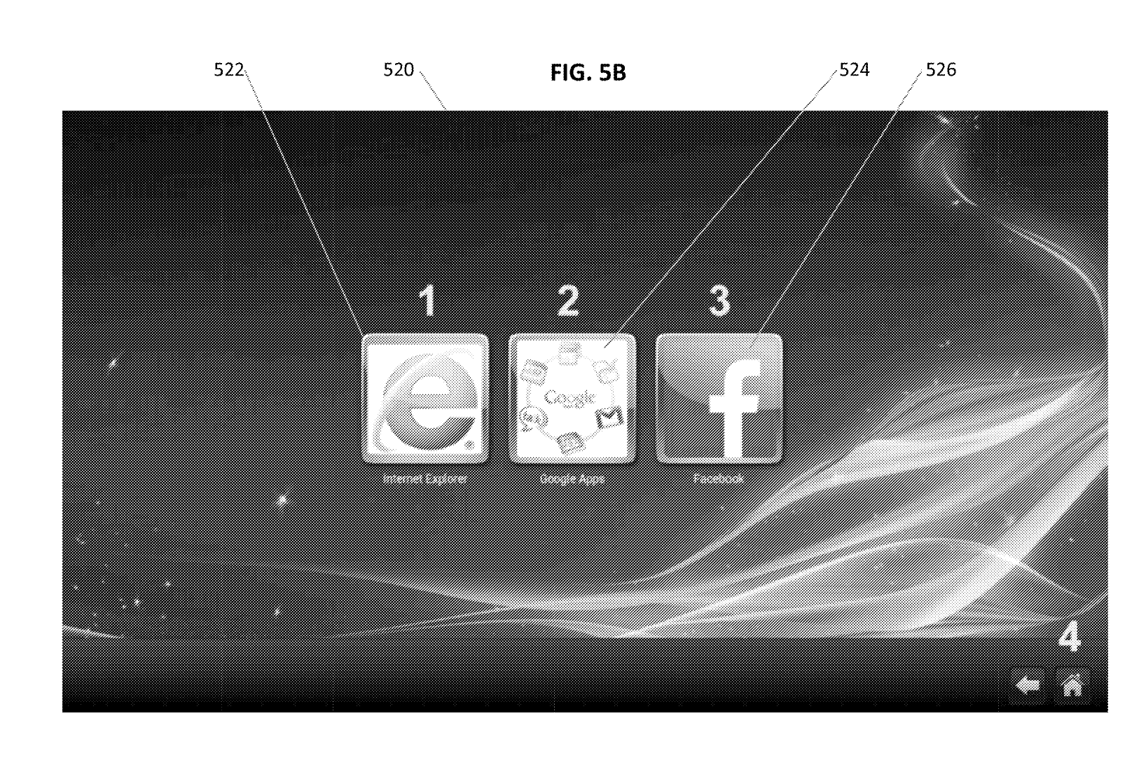

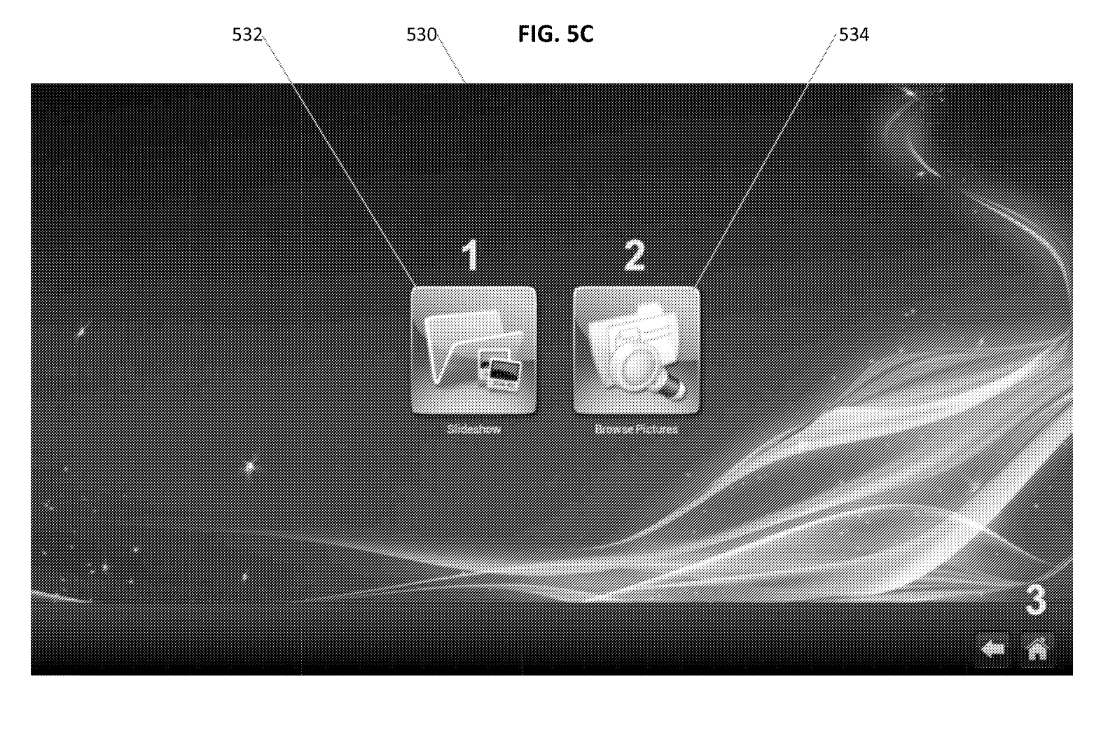

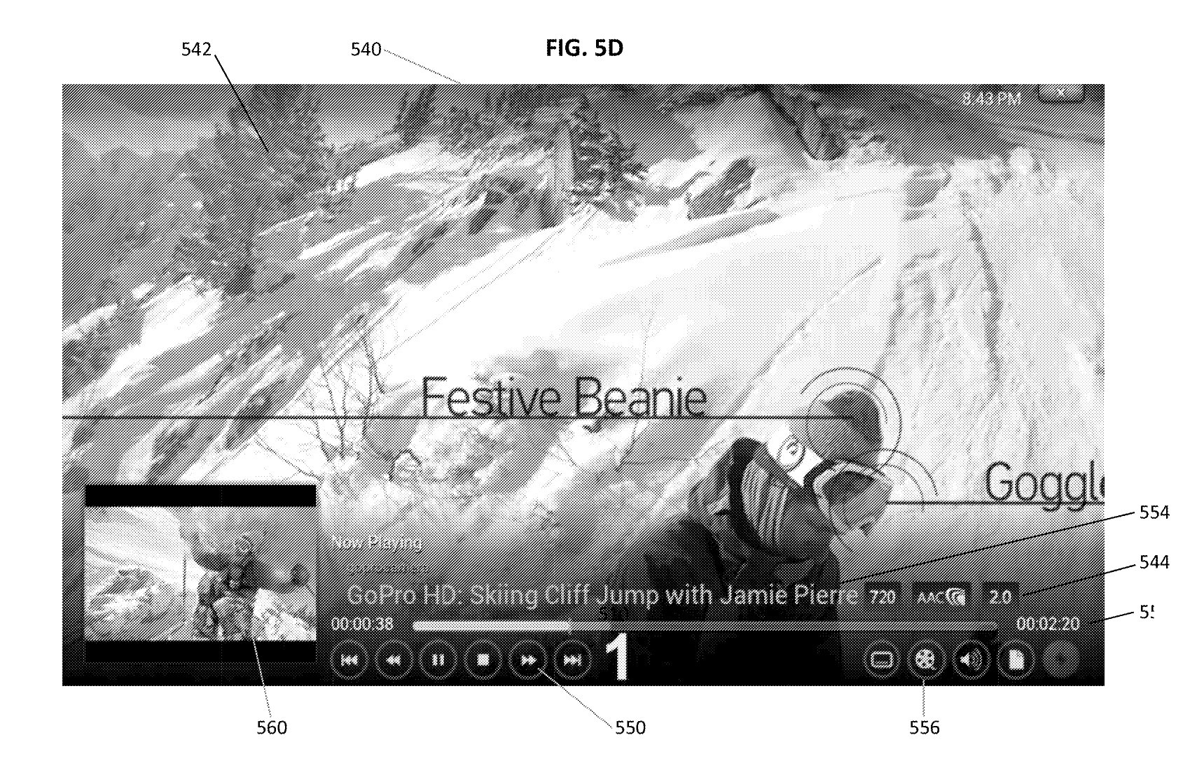

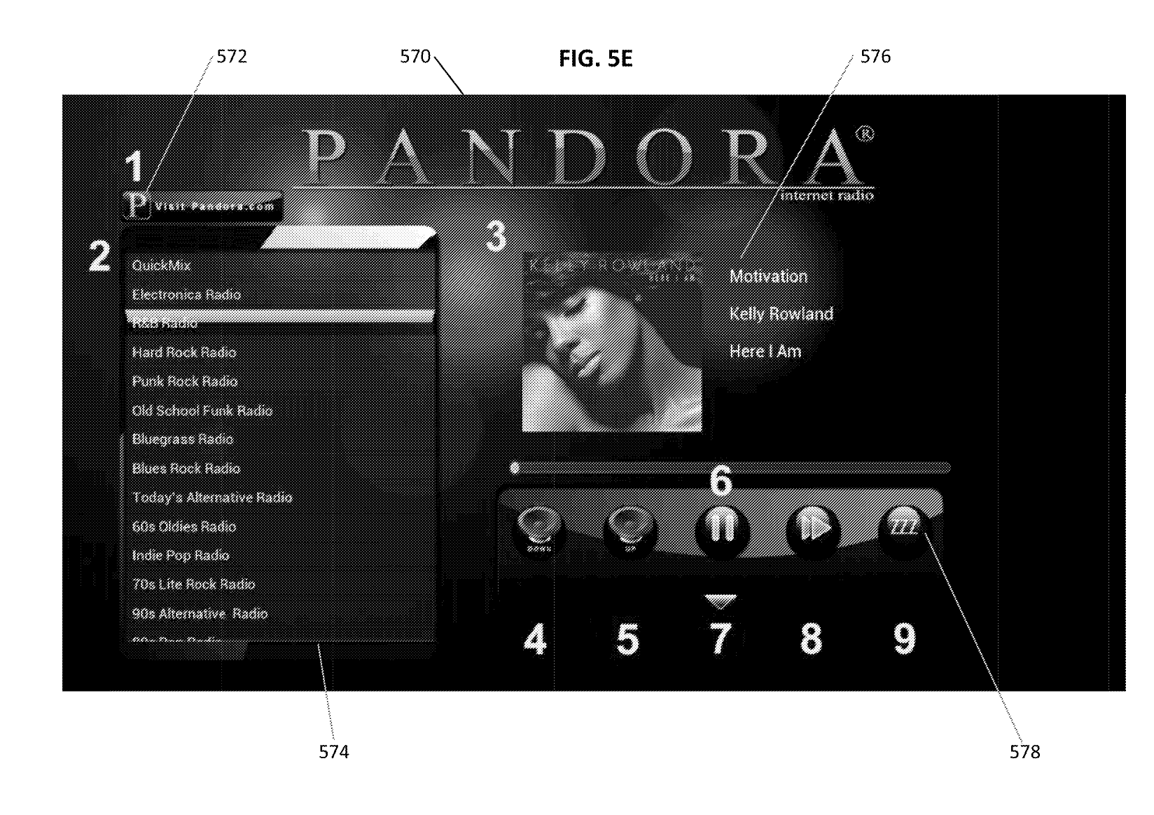

FIGS. 5A-5E show example control menus that are displayed when certain of the icons 410, 412, 414, 416, 418, 420, 422, 424, 426 and 428 in FIG. 4 are selected. FIG. 5A is an image of a screen 500 that is displayed when the game icon 410 is selected. The screen 500 allows control of different features when the system 200 is operating an interactive, immersive activity such as the sports simulation game in FIG. 2-3. The screen 510 includes a website icon 512 that allows a user to visit the website of the game manufacturer. A theme icon 514 allows a user to change the theme of the system 200 by selecting from available themes. Two volume controls 516 and 518 allow the user to adjust the volume of the speakers 224 in FIG. 2.

FIG. 5B is an image of a screen 520 that is displayed when the Internet browser icon 418 is selected. The control screen 520 includes a browser icon 522, an applications icon 524 and a social media icon 526. The browser icon 522 will activate a generic Internet web browser. The applications icon 524 allows access to certain on-line applications such as email, spreadsheets, documents, etc. The social media icon 526 allows access to a social media site. Of course other icons that activate specific Internet sites may be included in the screen 520.

FIG. 5C is an image of a screen 530 that is displayed when the digital picture viewer icon 420 is selected. The screen 530 includes a slide show icon 532 that allows the display of slide show of stored pictures in any area or the viewable surfaces 102, 104, 106 or all of them. The screen 530 includes a browse pictures icon 534 that allows a user to browse for other pictures on storage devices accessible by the system 100 in FIG. 1.

FIG. 5D is an image of a video screen area 540 that may be displayed in any area or the viewable surfaces 102, 104, 106. The screen area 540 may also be split between the viewable surfaces. The video screen area 540 is activated by selection of a video from any source such as selecting the online video streaming service icon 416, the television viewer icon 424, or the online video streaming service or player icon 426. The video screen area 540 includes a general area 542 for showing the selected video and a controls area 544 which may be hidden from the viewer. The controls area 544 includes a set of video controls 550 that includes previous video/chapter, rewind, pause/play, stop, fast forward and next video/chapter controls. The controls area 544 includes a time line 552 that shows the running time of the video. The controls area 544 includes an informational area 554 that includes the format, the title and other information about the video. A video system control area 556 includes controls to hide the controls area 544, control volume, and access other video files. An inset screen 560 may show another video.

FIG. 5E shows an image of a screen 570 that is displayed when the online streaming music service icon 414 is selected. The screen 570 includes an account management tab 572 that allows the user to manage their music service account. A category list 574 shows the user's favorite categories of music. A currently playing area 576 shows information and graphics associated with the song currently playing. A control area 578 includes volume controls, pause, display video, song controls, and change to another category controls.

The simulation controller 110 can be configured to superimpose at least part of the television content with at least a portion of the simulated sports game such that the television content and the sports game are simultaneously viewable while the sports game is being played by the human user in a third mode. The third mode allows designated areas of the display to enhance the experience of the user operating the simulation activity in the first mode of the system 100. In an example of a golf simulation game, the television content may be of a live or recorded golf match at a golf course.

Further, the simulation controller 110 may configure the simulated sports game to portray the same sport venue corresponding to the live or recorded sporting game such that the human user plays. For example, in the golf simulation game, the simulation controller 110 may display on the simulated golf game the same location on the same golf course as that being played by a golf player in the live or recorded golf match. Alternatively, the television content may be slightly less opaque so that the two images are superimposed simultaneously on the video display system 100. The camera angle can be matched so that the player of the simulated sports game is oriented in the same direction as the player on the television. The simulation controller 110 may be configured to display a live or recorded video of the player on television playing a sport on a first of the one or more actively viewable surfaces 102, 104, 106 while simultaneously displaying the simulated sport game on at least a second of the one or more actively viewable surfaces 102, 104, 106. In this example, the player of the simulated golf game can “play alongside” a professional golf player on television during a live tournament. Alternately, pre-recorded television content of a professional player performing a sports skill or action, with or without a sports object, may be displayed simultaneously on the display system 100 while the player is playing the simulated sports game. In this manner, a player may compare their action in relation to a sports object with a professional performing the same action on the same sporting venue. For example, in a golf simulation game, a golfer hitting a ball may be portrayed simultaneously on the display system 100 while the player is playing the simulated golf game. The two golf balls may be simulated being struck and traveling along the course simultaneously so that the player can compare his or her strokes against that of the professional.

The simulation controller 110 can be configured to cause an avatar of an instructor to be displayed on the display system 100 simultaneously as the simulation of the sports or other game is being displayed. In a sports game, the instructor avatar may show different techniques for actions associated with the sports simulation. For example, in a golf simulation game, a player may match the swing of a club as the avatar instructor swings a club at the golf ball. The avatar may also represent a golf professional and mimic actual swings and plays made by the golf professional during a tournament, for example. In this way, an amateur player has the sensation that he or she is being trained or instructed by a professional golfer. The avatar in a first player role-playing game may offer tips as to the game or instruction of actions or using objects in the game.

As the television content and/or avatar is being portrayed on the display system 100, the menu screen 400 shown in FIG. 4 can be called up at any time. For example, the weather at the time and location of the course being portrayed on the television content can be called up by selecting the icon 420 on the menu and displayed on the display system 100 simultaneously with the simulated sports game. Video clips of other players such as professional athletes may be selected via the icons 416, 426 or 428 and displayed on one of the surfaces 102, 104 and 106 while the sports game is run on one of the other actively viewable surfaces 102, 104 or 106. In some configurations, a player may see the video clips in his or her peripheral vision while playing the simulated sports game. For example, video clips of professional golfers may display simultaneously on the viewable surface 104 or 106 or both while the simulated golf game is displayed on the viewable surface 102.

When the player wishes to take a break from playing the simulated sports game, the game can be suspended, and the icon 422 corresponding to the pictures icon can be selected to cause a slide show of digital photographs to be displayed on the display system 100 until the player resumes playing the sports game. When the television icon 424 is selected, a window portraying the television content can be superimposed over the simulated sports game on any portion of or on all of the surfaces 102, 104, 106, and the user can resize or move the window to any desired position or size, or can opt to have the television content occupy the entirety of the surfaces 102, 104, 106 in a full screen mode. In windowed mode, the television content may be displayed simultaneously with the simulated sports game on any portion of any surface 102, 104, 106.

The use of the above content enhances the immersive nature of the simulator system 200. The simulation controller 110 allows multiple users to use the display simultaneously. Users may interact with live video and recorded content as well as live and recorded gameplay with a single click solution on a large screen format where controls may be as simple as voice/motion commands or touch screen interfaces. The simulator system 200 may include surround sound systems and 3D technology to enhance the immersive nature of the simulation.

The simulator system 200 and functions enabled by the display system 100 allows athletes and sports enthusiasts alike the ability to privately train and compete across a wide range of sports and games. The display system 100 also allows recording game play as instruction for novices or further instruction of the player. Such recordings may be displayed in one of the other modes while the game is played in the first mode.

All of the features referred to in the disclosure regarding avatars for instruction as well as side-by-side simulation with live and recorded sporting events can also apply to a variety of sports and video game scenarios. Individuals wishing to increase their proficiency in a given skill in any number of sports could take advantage of both the instruction as well as the direct comparison in performance with professional players. This allows athletes and sports enthusiasts alike the ability to privately train and compete across a wide range of sports and games.

Any of the methods, algorithms, implementations, or procedures described herein can include machine-readable instructions for execution by: (a) a processor, (b) a controller, and/or (c) any other suitable processing device. It will be readily understood that the simulation controller 110 can include such a suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular embodiments and applications of the present disclosure have been illustrated and described, it is to be understood that this disclosure is not limited to the precise construction and compositions disclosed herein and that various modifications, changes, and variations can be apparent from the foregoing descriptions without departing from the scope of the invention as defined in the appended claims.

1. A display system for performing or practicing sports skills and viewing multimedia content, comprising:
a simulation controller;
a video display system having an actively viewable height of at least six feet or more, the video display system having one or more actively viewable surfaces; and
one or more input devices coupled to the simulation controller and configured to receive inputs from the human user or another user;
the simulation controller being configured to:
display on an area of the one or more actively viewable surfaces a user interactive, immersive simulated activity in a first mode; and
responsive to receiving a first input from the one or more input devices, activate a second mode in which multimedia content different from or unrelated to the user interactive, immersive simulated activity is simultaneously displayed on the one or more actively viewable surfaces in an area different from the area displaying the user interactive, immersive simulated activity.

2. The display system of claim 1, wherein the user interactive, immersive simulated activity is a first person role-playing game or a sports game wherein the user simulates playing the sport.

3. The display system of claim 1, wherein the content includes a menu of user-selectable icons, the icons being associated with any combination of at least the user interactive, immersive simulated activity, an online game playable via the Internet, an online streaming music service, an online video streaming service, an Internet browser, an online weather forecast service, a digital picture viewer, a television viewer, or a digital disc player.

4. The display system of claim 3, wherein the user-selectable icons are selectable via the one or more input devices, the simulation controller being configured to, in response the selection of a first of the user-selectable icons, causing a function associated with the selected user-selectable icon to be executed.

5. The display system of claim 4, wherein the online streaming music service streams content from an Internet radio or music streaming service.

6. The display system of claim 4, wherein the television viewer streams television content from a broadcast telecast source, a cable television provider, a direct-broadcast satellite source, a network media storage device, or a webcast source.

7. The display system of claim 6, wherein the user interactive, immersive simulated activity is a simulated sport, and wherein the simulation controller is further configured to operate a third mode including superimposing at least part of the television content with at least a portion of the sport such that the television content and the sport are simultaneously viewable while the simulated sport is being played by the human user.

8. The display system of claim 7, wherein the television content is of a live or recorded sporting event at a sports venue, the simulation controller configuring the simulated sport to portray the same sports venue corresponding to the live or recorded sporting event such that the human user plays on a simulated sports venue identical to the sports venue as that being played in sporting event.

9. The display system of claim 6, the simulation controller being configured to display a live or recorded video of a human player playing the sport on a first of the one or more actively viewable surfaces while simultaneously displaying the simulation of the sport on at least a second of the one or more actively viewable surfaces.

10. The display system of claim 2, wherein the simulation controller is configured to cause an avatar of an instructor to be displayed on the display system simultaneously as the simulation of the sports game or first player role-playing game is being displayed.

11. The display system of claim 4, wherein the simulation controller uses an open source media player to portray on the video display system at least some of the functions associated with the icons.

12. The display system of claim 1, wherein the human user is positioned in front of the video display system and the one or more actively viewable surfaces at least partially surround the human user by at least 120 degrees.

13. The display system of claim 1, wherein the actively viewable height is at least ten feet.

14. The display system of claim 1, wherein a width of the video display system is substantially 20 feet.

15. The display system of claim 1, wherein the video display system includes a video projector.

16. The display system of claim 1, wherein the viewable display surfaces include one of LCD, LED, OLED, plasma, or quantum dot displays.
